(19) United States
(12) Patent Application Publication
(10) Pub. No.: US 2003/0048911 A1
(43) Pub. Date: Mar. 13, 2003

(54) Miniature speaker with integrated signal processing electronics

(76) Inventors: Claus Erdmann Furst, Roskilde (DK); Lars Jorn Stenberg, Roskilde (DK); Leif Johannsen, Odder (DK)

Correspondence Address: HARNESS, DICKEY & PIERCE, P.L.C., P.O. BOX 8910, RESTON, VA, 20195, US

(21) Appl. No.: 10/237,872

(22) Filed: Sep. 10, 2002

Related U.S. Application Data
(60) Provisional application No. 60/318,524, filed on Sep. 10, 2001.

(51) Int. Cl. H04R 3/00

(52) U.S. Cl. 381/96

(57) ABSTRACT

A miniature speaker having built-in electronic components for providing a feedback signal for dynamically adjusting acoustical parameters of the miniature speaker. The miniature speaker includes in the preferred embodiment a housing, a magnetic circuit, a coil, a diaphragm, a sensor, and an electronic circuit. The sensor is formed by the metallized portion of the diaphragm and the metallized portion of the housing cover. The two metallized portions form a plate capacitor, and as the diaphragm vibrates, the capacitance of the plate capacitor changes. These changes are converted into a feedback signal which is combined with the input audio signal in an electronic circuit mounted directly on the diaphragm and which drives the speaker while adjusting acoustical parameters, such as resonance, distortion, and sensitivity. The feedback signal can also be used to protect the active components of the miniature speaker against mechanical stress, thereby prolonging the lifetime of the speaker.

### FIELD OF THE INVENTION

This invention relates to an acoustical miniature transducer, and more particularly, to a miniature speaker having built-in components to actively compensate for acoustical anomalies.

### BACKGROUND OF THE INVENTION

Miniature speakers are widely used in a variety of small portable devices, such as mobile phones, music players, personal digital assistants, hearing aids, earphones, portable ultrasonic equipment, and so forth, where small size is paramount. Users of such devices appreciate their small size, but would prefer not to compromise sound quality at desired sound level. However, the small physical size of the miniature speaker limits the maximum mechanical output power of the speaker. In addition, these devices are typically battery operated, which further limits the amount of electrical power available to drive the miniature speaker. Accordingly, the miniature speaker is often driven to the limits of its mechanical capabilities in order to maximize mechanical output. Over-driving a miniature speaker causes mechanical stress on the components of the miniature speaker and negatively impacts the speaker's lifetime and in particular its sound quality by causing distortion, resonance, and other unwanted acoustical anomalies.

These acoustical anomalies can be reduced by altering the design of the miniature speaker, but design alterations can be costly and require trade-offs of many competing design considerations. Moreover, different customers may have different requirements. For example, sound quality in a mobile phone may not be as critical as sound quality in a portable music player. These varying requirements would require a redesign in each instance, thus increasing the overall cost of manufacturing miniature speakers to different customers.

Integration of electronics drive circuitry in the miniature speaker is one way to release some design constraints. Thus, there exists a need for a miniature speaker that includes an electronic circuit having built-in components that actively compensate for acoustical anomalies.

### SUMMARY OF THE INVENTION

A miniature speaker according to the present invention includes a housing, a “motor” performing more or less linear conversion of the electrical input signal to mechanical movements, a sensor for providing a feedback signal, and an electronic circuit. An electrical input signal at audible or ultrasonic frequencies is provided as an analog signal or a digital signal to the electronic circuit. The electronic circuit includes driver circuitry to drive the motor. The electronic circuit is attached to a diaphragm which is the part of the motor emitting acoustical energy.

In a preferred embodiment of the invention, the motor is based on electromagnetic principles, and includes a magnetic circuit and a coil which together drive a diaphragm. As analog electrical signals are passed through the coil, a magnetic field is formed. Changes in the magnetic field cause the coil and diaphragm to move, and the air-pressure disturbances caused by the movements in the diaphragm create acoustical energy.

The sensor is positioned inside the housing of the speaker (or in close proximity to the housing) to detect changes in the magnetic field or to detect the movement of the diaphragm. In a specific embodiment, the sensor is a plate capacitor, whose plates are formed by a conductive layer of the diaphragm and a conductive layer of the cover of the housing. Acoustical vibrations in the diaphragm cause changes in the capacitance of the plate capacitor, and these changes are converted into a digital or analog feedback signal. The electronics driver circuitry combines the electrical input signal and the feedback signal to eliminate or reduce acoustical anomalies, such as resonance peaks or dips or distortion, and/or to detect mechanical stress on the active components (for example, the diaphragm). In one specific embodiment, the electronics driver circuitry subtracts the feedback signal from the audio signal, thereby creating a feedback loop.

In alternate embodiments, the sensor may be a coil, a microphone, or an accelerometer, the electronic circuit may include a Class A, B, or D amplifier, pulse width modulated (PWM) or pulse density modulated (PDM) driver circuitry, a digital signal processor, or an analog-to-digital converter, such as a sigma delta converter. The electronic circuit is preferably mounted within the housing such as to the diaphragm, or it may be disposed outside the housing. The electronic circuit may be implemented in a monolithic integrated circuit (IC), which may be surface mounted or wire-bound to a substrate or PCB in the housing or to the diaphragm. Alternatively, the electronic circuit may be a substrate with multiple ICs disposed thereon. The electrical input signal may be an analog audio signal or a formatted digital audio signal formatted according to a digital format such as S/PDIF, AES/EBU, I2S, PCM or the like. The active feedback compensation of the present invention permits dynamic compensation for acoustical anomalies, such as distortion and resonances, and reduces mechanical stress on the active components in the speaker.

The above summary of the present invention is not intended to represent each embodiment, or every aspect, of the present invention. This is the purpose of the figures and the detailed description which follow.

### BRIEF DESCRIPTION OF THE DRAWINGS

The foregoing and other advantages of the invention will become apparent upon reading the following detailed description and upon reference to the drawings.

FIG. 1a is a perspective exploded view of a miniature speaker according to a preferred embodiment of the present invention.

FIG. 1b is a bottom perspective exploded view of the miniature speaker shown in FIG. 1a.

FIG. 1c is a top view of the transducer shown in FIGS. 1a and 1b illustrating the stationary part of the motor.

FIG. 1d is a top view of the coil of the transducer shown in FIGS. 1a and 1b, at an intermediate production stage.

FIG. 2 is a side cross-sectional view of the miniature speaker shown in FIG. 1.

FIG. 3 is a functional block diagram of a miniature speaker according to one embodiment of the present invention.

FIG. 4 is a functional block diagram of a miniature speaker according to another embodiment of the present invention.

FIG. 5 is a functional block diagram of a miniature speaker according to yet a further embodiment of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF ILLUSTRATIVE EMBODIMENTS

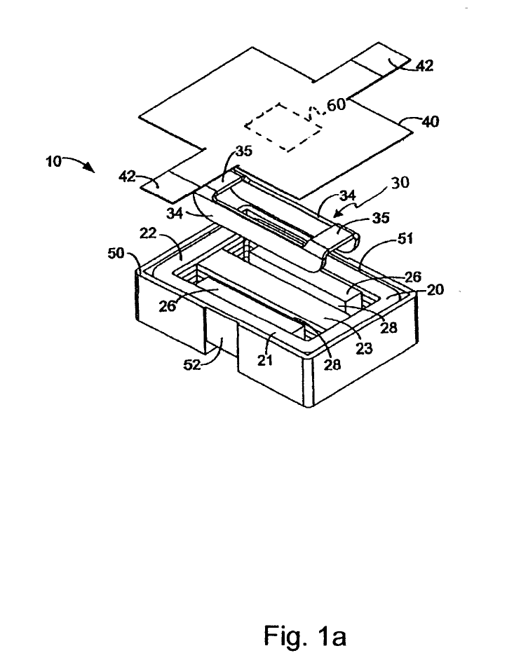

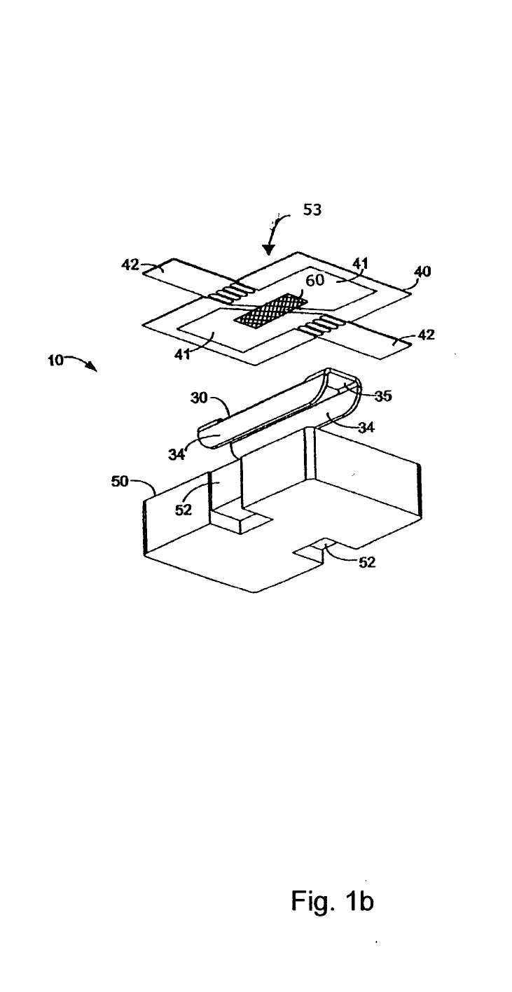

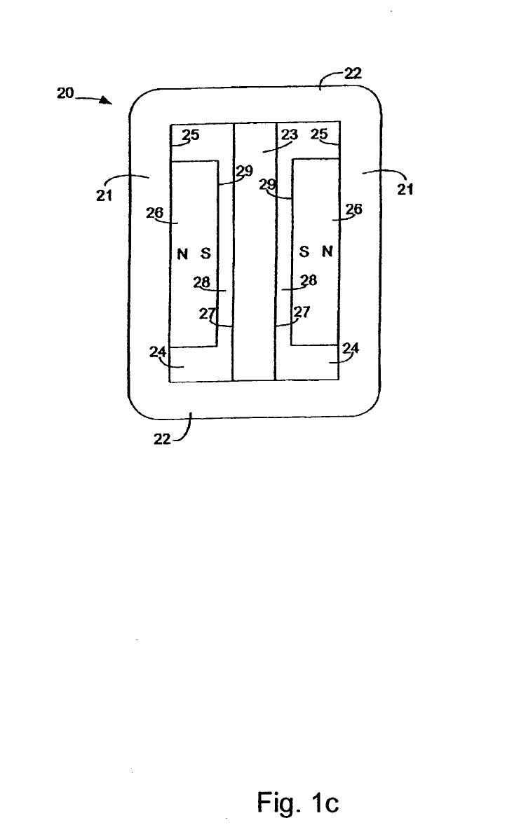

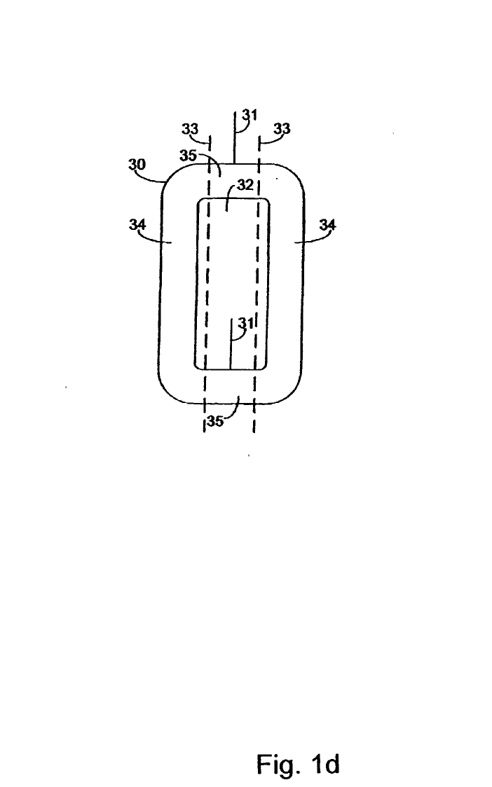

FIGS. 1a-1b illustrate exploded views of a transducer 10 which generally includes a motor comprising a magnetic circuit 20 and a coil 30, which drive a diaphragm 40, and an electronic circuit 60 that is located on the bottom surface of the diaphragm 40. The magnetic circuit 20, the coil 30, and the diaphragm 40 are housed within a housing or casing 50. In the illustrated embodiment, the casing 50 has a generally rectangular shape, but in alternate embodiments, the casing 50 may have a generally cylindrical or circular or polygonal shape. In these alternate embodiments, the magnetic circuit 20 and the diaphragm 40 have a generally circular or polygonal shape to fit within the cavity defined by the casing 50. The casing 50 may be made of an electrically conducting material such as steel or aluminum, or metallized non-conductive materials, such as metal particle-coated plastics. The metallization of the casing 50 substantially shields against the effects of undesired EMI.

As shown best in FIG. 1c, the magnetic circuit 20 has a generally rectangular outer shape with two long members 21 and two short members 22 connected at their ends to form a ring of generally rectangular shape. A central member 23 interconnects the two short members 22 dividing the inner portion of the rectangular ring into two rectangular openings 24. The two long members 21, the two short members 22, and the central member 23 of the magnet circuit 20 are of a magnetically soft material preferably having a high magnetic saturation value. The two long members 21 have inner edges 25 facing towards the openings 24. A magnet 26 is attached to the inner edge 25 of the two long members 21. The magnets 26 each have a magnetic pole facing each long member 21 and an opposite free magnetic pole facing towards the openings 24. Magnet gaps 28 are defined between the free magnetic pole facing towards the openings 24 and the inner faces 27 of the central member 23.

In an alternative embodiment the magnets 26 are attached to the central member 23. Thus, the magnets 26 each have a magnetic pole surface attached to the middle leg 23 and the opposite free magnetic pole surface facing the opening and the opposed plane surface 25 of the two long members 21, whereby the magnetic gaps 28, instead of being positioned between the central member 23 and the magnets 26, are defined between the free magnetic pole surfaces and the surfaces 25 of the two long members 21.

Each magnet 26 creates a magnetic field in the corresponding magnet gap 28, and the magnetic return paths are defined through the central member 23, the short members 22, and the long members 21. The magnetic return paths thus completely encircle the magnet gaps 28 and concentrates the magnetic field in the magnet gaps 28. In this respect, the magnetic circuit 20 has a very flat and compact structure that yields a low stray magnetic field, which results in high sensitivity, and diminishes the need for magnetic shielding. In FIGS. 1a and 1b, the magnet circuit 20 in FIG. 1c is situated in a casing 50, such as by molding or by placement into a preformed case. The casing 50 may be made of plastic or any other suitable material, and may optionally include a bottom that covers the openings 24, such as shown in FIG. 1b.

FIG. 1d illustrates the coil 30 used in the transducer 10 in an intermediate production stage. The coil 30 is wound of electrically conducting thin wire such as copper and includes a number of turns which are electrically insulated from each other, such as by means of a surface layer of lacquer. The coil 30 has a coil axis perpendicular to FIG. 1d. As is known in the art, the coil 30 is heated during winding, and the heating causes the lacquer to become adhesive. During heating, the lacquer adheres the windings to each other. The coil 30 has two free wire ends 31 for connecting the coil 30 electrically to other electronic circuits.

The coil 30 is wound on a mandrel having a generally rectangular cross-section to give the coil 30 a generally rectangular shape as shown in FIG. 1d. The coil 30 has a generally rectangular opening 32 and a generally rectangular outer contour having rounded corners. In the illustrated embodiment of FIG. 1d, the coil 30 is substantially flat and has a thickness which is less than its radial width between its inner and outer dimensions. In one embodiment, the coil 30 has a thickness of approximately 10 to 30 percent of the radial width.

After the coil 30 has been wound with the desired number of turns of wire and to the desired shape and thickness, it is removed from the mandrel. While the coil is still warm, and the lacquer is still soft, the coil is bent along two substantially parallel bending axes 33 shown in FIG. 1d using a bending instrument (not shown). After bending, the coil 30 has the shape shown in FIGS. 1a and 1b, where the two long members 34 of the coil have been bent approximately 90 degrees relative to the short members 35, and the two long members 34 are substantially parallel to each other. Subsequently, the coil 30 is allowed to cool until the lacquer hardens.

In one embodiment, the bent and stabilized coil 30 is secured to the diaphragm 40. The diaphragm 40 is made from a thin and flexible sheet. On the top and bottom surfaces of the diaphragm 40 shown in FIG. 1b, the diaphragm 40 includes electrically conductive portions 41 (bottom side) and 53 (top side—not shown), which are electrically insulated from each another. The electrically conductive portions 41 are made of a conducting material, such as copper. The two short members 35 of the coil 30 are secured to the bottom surface of the diaphragm 40, such as by means of adhesive, and the two wire ends 31 are electrically connected to respective tongues 42 of the electrically conductive portions of 41, such as by glueing, soldering or welding. The fact that the wire ends are connected directly to the diaphragm significantly reduces the risk of breaking/damaging the wires when the transducer is operated, i.e. the diaphragm is moved since the coil is secured to the diaphragm 40. However, the wire ends may alternatively be electrically connected to terminals on the casing, e.g. by soldering.

The diaphragm 40 is generally rectangular in shape and includes tongues 42 extending from the long sides of the diaphragm 40. The electrically conductive portions 41 are patterned for connecting wire ends 31 of the coil 30 to the appropriate terminals of the electronic circuit 60 and connecting other terminals of the electronic circuit 60 to connection points on the tongues 42 for external access. The electrically conductive portions of 41 which should not be in electrical contact with the wire ends of the coil 30 or the terminals of the electronic circuit 60), are connected to an external AC ground terminal so these portions of 41 prevents electrical field lines emerging from the coil 30 to reach the top side conductive layer 53 of the diaphragm.

The electronic circuit 60 (FIGS. 1a and 1b) is secured to the diaphragm's 40 bottom side such as by welding, soldering, or glueing. The conductive portion 53 on the top side forms a first plate of a capacitive sensor. The conductive portion 53 is electrically connected to the appropriate terminal of the electronic circuit 60 by a feedthrough in the diaphragm. The electronic circuit 60 is dimensioned to fit within the opening 32 of the coil 30 shown in FIG. 1d after the coil 30 has been bent. Additional details of the electronic circuit 60 are discussed below.

The diaphragm 40, which has the coil 30 and the electronic circuit 60 secured thereto, is mounted on top of the magnet circuit 20 such that the two long members 34 of the coil are disposed in respective ones of the magnet gaps 28. The two short members 35 of the coil 30 are situated over the central member 23 as shown in FIG. 1a. The diaphragm 40 has a width corresponding to the distance between the inner sides of the long edges 51 of the casing 50.

The long edges of the diaphragm 40 may be secured to the magnet circuit 20 or the casing 50 with an adhesive. Alternatively, the slot can be closed with a flexible substance so as to allow the edges to move. In one embodiment, the two short sides of the diaphragm are free and define a narrow slot between the short side of the diaphragm 40 and the edge of the casing 50. The slot is dimensioned to tune the desired acoustical parameters of the transducer 10, particularly at low frequencies. In another embodiment, the two short sides of the diaphragm 40 are secured to the magnet circuit 20 or the casing 50. In the illustrated embodiment of FIGS. 1a and 1b, the diaphragm has a generally rectangular shape, but in other embodiments, the diaphragm may have other shapes, such as square, circular, or polygonal.

In an alternative embodiment, the coil may be formed by a thin and flexible sheet, such as a flexible printed circuit board, i.e. a flexprint. Such thin and flexible sheet will carry a predefined electrically conductive path thereon so as to form a coil-like electrical path. As explained later, the diaphragm will also in its preferred embodiment have electrically conductive portions. Therefore, the coil and diaphragm can be made from a single sheet of flexprint with appropriate conductive paths, and this sheet will be shaped in such a way that the two long sections of the coil will emerge and have an angle of 90 degrees with respect to the rest of the integrated diaphragm/coil structure.

Referring again to FIG. 1a, the magnet circuit 20 includes several layers, and the uppermost layer of the central member 23 is omitted. The “missing” layer of the central member 23 allows room to accommodate the short members 35 of the coil 30 and the electronic circuit 60. In alternate embodiments, the central member 23 may be missing more than one layer to accommodate a thicker coil 30 and/or a thicker electronic circuit 60. In another embodiment, the magnet circuit 20 is made as a solid block and the central member 23 is inserted inside the opening of the solid block.

FIGS. 1a and 1b show two grooves or channels 52 in the casing 50 that run down the long sides of the casing 50 and terminate on the bottom of the casing 50 as shown in FIG. 1b. The channels 52 have a width corresponding approximately to the width of the tongues 42. The tongues 42 are bent and received in respective ones of the channels 52. The ends of the tongues 42 are bent again and received in the part of the channels 52 terminating at the bottom of the casing 50. The ends of the tongues 42 may have a conductive layer on both sides of the ends, such that when the ends of the tongues 42 are bent into the channels 52 terminating on the bottom of the casing 50, the conductive layer of the ends of the tongues 42 are exposed. The ends of the tongues 42 function as electrical terminals of the transducer for connection to other electronic components. In another embodiment, the ends of the tongue 42 do not have an exposed conducting layer, and through-plated holes may be formed in the ends of the tongue 42 to establish an electrical connection with the transducer 10 and other electronic components. For some applications, such as mobile phones, it may be interesting to connect the transducer to external electronic equipment by directly soldering the conductive portions of the tongues 42 to conductive portions of a circuit board. Alternatively, the end portions of the conductive portions 42 of the tongues can be soldered or by other means connected to electrical terminals (not shown) mounted in the grooves 52 of the casing 50.

In the shown embodiments the transducer has only two electrical terminals. One or more additional terminals may be required for some applications utilising the integrated signal processing electronics. Typically, at least three terminals are required: supply voltage to the integrated electronics, ground and one for digital or analog signal input. For some applications even more terminals may be necessary. Such additional external terminals may be established by adding tongues 42 of the types described above.

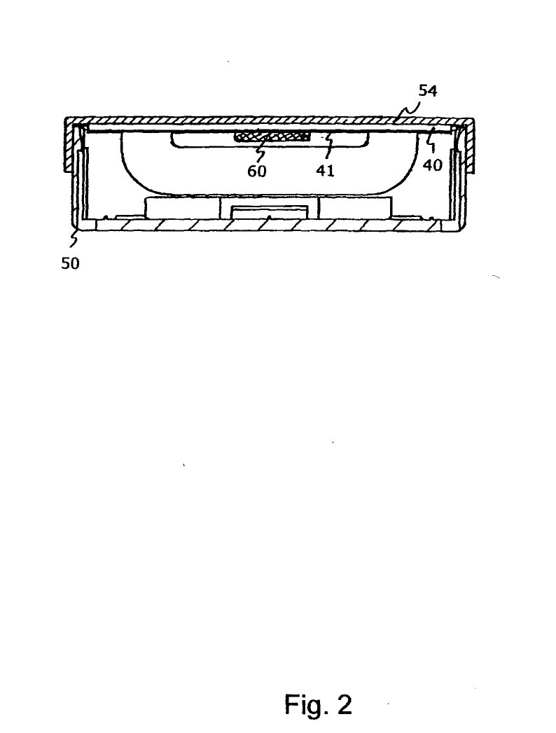

The transducer 10 includes a front cover 54 (FIG. 2), which is placed over the diaphragm 40. The front cover 54 may include openings to facilitate the emission of acoustical energy from the diaphragm 40. The front cover is either electrically conductive or fitted with an electrical conductive layer which acts as the second plate in the sensor capacitor mentioned before.

As explained above, in one embodiment, the diaphragm 40 is secured to the magnet circuit 20 along the long edges of the diaphragm 40 while its short edges are free. Conventional diaphragms are secured along the entire periphery of the transducer. The free edges of the diaphragm 40 of the present invention result in the transducer 10 having a relatively high compliance even with a relatively thick diaphragm.

When electrical input signals at audible for ultrasonic frequencies are supplied to the terminals at the tongues 42, the resulting current in the gaps between the wires of the coil 30 interact with the magnetic field in the magnet gaps 28 and cause the coil 30 and the diaphragm 40 to move. The movement of the diaphragm 40 generates acoustical energy at the audio frequencies.

The motor of FIG. 1a includes the magnet circuit 20 and the coil 30, which drive the diaphragm 40. The motor may also be of the design that includes a moveable armature (not shown) extending through a tunnel defined by a wire coil and through a magnetic gap defined by a pair of spaced magnets. The input signal to the coil causes a change in the magnetic field within the coil tunnel that causes the armature to move. Because the armature is coupled to the diaphragm via a drive pin, the input signal results in a corresponding movement in the diaphragm.

In the example of an embodiment shown in FIGS. 1a and 1b, the transducer 10 has dimensions of about 11 mm (L)×7 (W)×4 (H), where L is the length of the long edge of the casing 50, W is the length of the short edge of the casing 50, and H is the height of the casing 50 measured from the bottom of the casing 50 to the top of the front cover 54. The volume of the transducer 10 shown in FIGS. 1a and 1b is about 308 mm³, but in alternate embodiments, the volume of the transducer 10 is less than about 6000 mm³. In general, the transducer 10 is sized to fit into a small portable device, such as a compact mobile phone, portable audio or video player, personal digital assistant, hearing aid, earphone, portable ultrasonic equipment, or any other suitable portable device. The diaphragm 40 has approximate dimensions (excluding the tongues 42) of 11 mm (L)×7 mm (W), or a surface area of approximately 77 mm². In alternate embodiments, the diaphragm 40 can be made larger so as to provide increased output such that its surface area is less than about 650 mm² (or approximately 1.0 in²). The mentioned dimensions are examples of a preferred embodiment of the transducer. The dimensions of the transducer according to the invention can be chosen arbitrary in order to suit various applications.

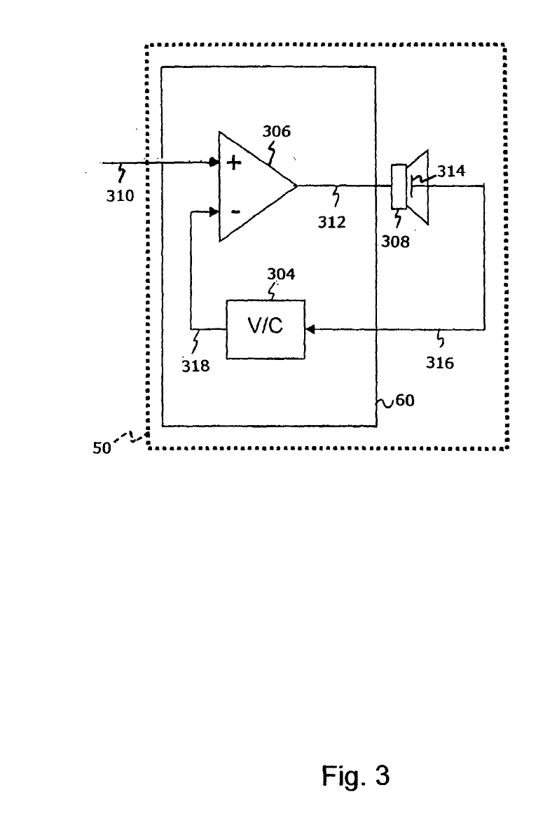

FIG. 2 shows a cross-sectional view of the transducer 10 that lacks the magnetic circuit 20, but shows the cover 54 that closes the cavity defined by the casing 50. The cover 54 is made of an electrically conducting material such as steel or aluminum, or metallized non-conductive materials, such as metal particle-coated plastics. In an al5 ternate embodiment, the cover 54 is made of a non-conducting material such as plastic and includes a conducting layer made of a conducting material such as steel or aluminum, or metallized non-conductive materials, such as metal particle-coated plastics. The placement of the cover 54 forms a plate capacitor, where one plate is the conducting layer of the cover 54 and the other plate is the conducting layer of the top surface 51 of the diaphragm 40. As the distance between the two plates vary as a result of the diaphragm movements or vibrations, the capacitance varies, and these changes in capacitance can be translated into electrical signals provided to the electronic circuit 60 as described in more detail in connection with FIGS. 3-5. The plates of the plate capacitor are electrically coupled to the electronic circuit 60, such as by means of wires or solder.

The electronic circuit 60 is disposed on the bottom surface 41 of the diaphragm 40 as shown in FIG. 2. In alternate embodiments, the electronic circuit 60 may be an integrated circuit which is surface mounted, flip-chip mounted, or wire-bonded on a substrate or PCB within the casing 50. Although the electronic circuit 60 is shown in FIG. 2 on the bottom surface 41 of the diaphragm 40, the electronic circuit 60 may be disposed on the opposite surface of the diaphragm 40, at a different location in the casing 50, or the electronic circuit 60 may be disposed outside the casing 50. However, it is preferred that the electronic circuit 60 be located within the casing 50.

FIG. 3 illustrates a functional block diagram of the miniature speaker 10 in accordance with one embodiment of the present invention. The block diagram generally shows the speaker casing 50 and the electronic circuit 60, which includes a sensor-signal-to-voltage converter (V/C) 304 and an amplifier 306. The motor 308 is the mechanical device for producing the acoustic energy and generally includes the magnetic circuit 20 and the coil 30, which drive the diaphragm 40. In the illustrated embodiment, the speaker casing 50 encloses the electronic circuit 60.

An electrical input signal is provided on line 310 to an input of the amplifier 306. The electrical input signal in FIG. 3 is an analog signal in the audible or ultrasonic frequency ranges. The output of the amplifier 306 is provided on line 312 to the motor 308. A sensor 314 is positioned on or near the diaphragm to detect the movement of the diaphragm, such as shown in FIG. 2. The sensor 314 may detect the diaphragm movements directly or indirectly. For example, the sensor 314 is a plate capacitor, such as shown in FIG. 2, which directly detects movements of the diaphragm. In another embodiment, the sensor 314 is a coil which senses at least a portion of the magnetic field generated by the motor 308, thus indirectly detecting movements of the diaphragm. In still another embodiment, the sensor 314 is an accelerometer, such as a piezoelectric accelerometer, that is directly mounted on the diaphragm. The sensor 314 could also be a microphone that detects the acoustical signal produced by the motor 308.

The sensor 314 provides a feedback signal on line 316 to the V/C 304. The feedback signal on line 316 is representative of the diaphragm movements In one embodiment, the V/C 304 is a switched capacitor circuit. In alternate embodiments, the V/C 304 may be a capacitor-to-voltage converter or a capacitor-to-frequency converter. The output of the V/C 304 is provided on line 318 to the amplifier 306.

The amplifier 306 is preferably a Class A or Class B difference amplifier. The amplifier 306 receives as inputs the electrical input signal on line 310 and the analog feedback signal from the V/C 304 on line 318. The feedback signal is subtracted from the electrical signal in the amplifier 306, amplified, and provided on line 312 to the motor 308. In this manner, acoustical anomalies such as resonance, distortion, and other undesired anomalies are reduced by the active feedback loop construct of the present invention.

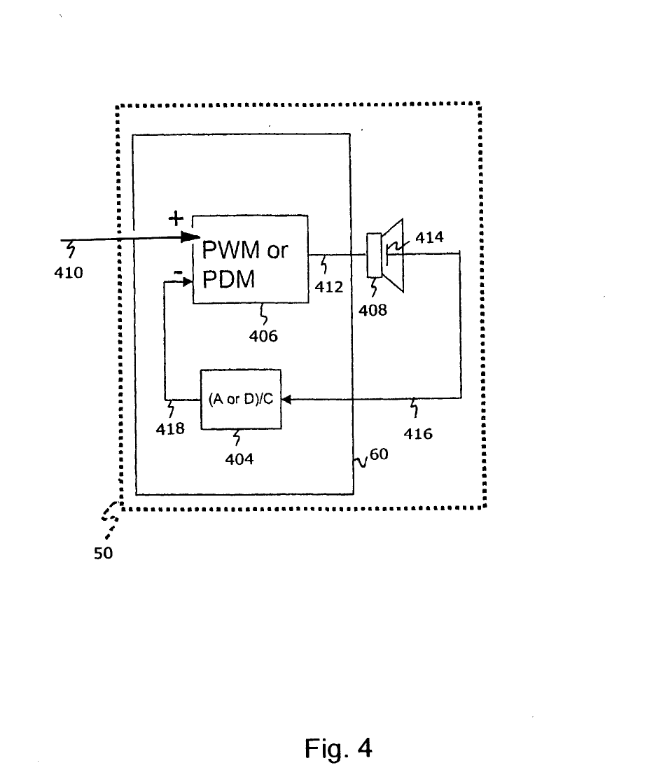

Turning now to FIG. 4, there is shown another functional block diagram of a miniature speaker in accordance with another embodiment of the present invention. The speaker casing 50 generally includes the electronic circuit 60 with a signal converter 404 and an amplifier 406. Disposed within the speaker casing 50 is a motor 408, which generally is the magnetic circuit 20 and the coil 30, which drive the diaphragm 40. An analog electrical signal is provided on line 410 to the amplifier 406. The amplifier 406 is preferably a pulse width modulated (PWM) or pulse density modulated (PDM) Class D amplifier. The signal converter 404 converts the feedback signal from a sensor 414 on line 416 into an analog or digital electrical signal. In the case of an analog input signal on line 410, the signal converter 404 converts the feedback signal into an analog or digital signal on line 418.

In another embodiment of the present invention, the electrical input signal on line 410 is a digital audio signal in the audible or ultrasonic frequency ranges, and the signal converter 404 converts the feedback signal on line 416 from the sensor 414 into a representative digital feedback signal. The output of the amplifier 406 on line 412 drives the actuator 408. The sensor 414 directly or indirectly detects the movements of the diaphragm, and translates these movements into an electrical signal on line 416.

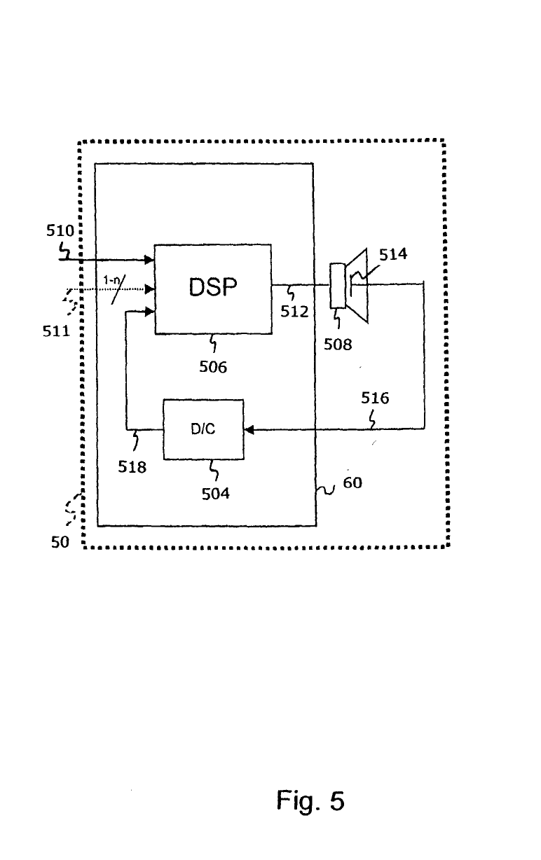

FIG. 5 illustrates yet another functional block diagram of a miniature speaker in accordance with one embodiment of the present invention. The speaker casing 50 generally includes the electronic circuit 60, which includes a sensor signal converter 504 and a digital signal processor (DSP) 506, and a motor 508, which again is generally the magnetic circuit 20 and the coil 30, which drive the diaphragm 40.

The feedback signal on line 516 from sensor 514 is digitized in the sensor signal converter 504 which provides a digital representation of the feedback signal on line 518 to the DSP 506. The converter 504 may be a multi-bit converter or a single-bit sigma delta converter.

The DSP 506 may optionally include control signals 511. The control signals 511 permit factory-adjustment or user-adjustment of sound characteristics, such as sensitivity, frequency response, or soft clipping at high output levels, or they may be used to reduce the mechanical stress of the motor, by reducing the drive levels when they exceed a predetermined threshold. In this manner, the lifetime of the miniature speaker may be prolonged and the sound quality integrity may be maintained.

The DSP 506 may perform filtering and shaping of the digital sound signals provided on line 510. When combined with the digitized feedback signal on line 518, the DSP 506 may optimize the frequency response of the miniature speaker by adjusting acoustical parameters such as bandwidth, distortion, sensitivity, flatness, shape, gain, and production spread, or by compensating for acoustical load changes.

In addition, the DSP 506 may include decoding circuitry for decoding a digital audio format, such as S/PDIF, AES/EBU, I2S, or any other suitable digital audio format. In this embodiment, the miniature speaker may be plugged into or incorporated directly into a device which is compliant with such digital audio format, thus eliminating the need for intermediate hardware. Note that the decoding circuitry may be incorporated into the DSP 506 in one embodiment or may be incorporated elsewhere in the electronic circuit 60 in another embodiment. In still another embodiment, the DSP 506 is a pure digital DSP and the electronic circuit 60 includes D/A circuitry such as PDM- or PWM-driver circuitry to convert the digital output signal into a drive signal on line 512.

As explained above, the DSP 506 may be used to reduce the mechanical stress on the active components in the transducer 10, such as on the motor and diaphragm. The DSP 506 compares the level of the feedback signal on line 518 with a predetermined level, such as the level of the electrical input signal on line 510. If this comparison exceeds a predetermined threshold, the DSP reduces the drive level on line 510 to a level within the predetermined threshold, or alternatively, the DSP outputs a signal, such as via one or more of the control signals 511, indicating that the drive level is too high. Additionally, if the comparison of the signals produces a certain, unusual result indicative of a mechanical failure, the DSP outputs a signal via the control lines 511 indicating that a speaker failure has occurred.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

1. A miniature transducer for converting an electrical input signal into acoustical output signal, said miniature transducer comprising:
a motor for driving a diaphragm for emission of said acoustical output signal,
a sensor for detecting a movement of said diaphragm, said sensor providing a feedback signal representative of the movement of said diaphragm, said sensor being a capacitive sensor with part of said sensor being said diaphragm, and
an electronic circuit electrically coupled to said motor, said electronic circuit providing an output signal to said motor for driving said diaphragm, said output signal being defined by said electrical signal and said feedback signal.

2. The miniature transducer of claim 1, further comprising a housing having a front plate, said capacitive sensor having a first plate and a second plate, said first plate defined by a conductive layer on said diaphragm and said second plate defined by said front plate.

3. The miniature transducer of claim 2, wherein said front plate includes a surface of an electrically conductive material.

4. The miniature transducer of claim 2, wherein said housing has a volume of less than about 6000 mm³.

5. The miniature transducer of claim 2, wherein said housing includes an electrically conducting material.

6. The miniature transducer of claim 1, wherein said electronic circuit is attached to said diaphragm.

7. The miniature transducer of claim 1, wherein said diaphragm has an area smaller than 650 mm².

8. The miniature transducer of claim 7, wherein said diaphragm has an area smaller than 100 mm².

9. The miniature transducer of claim 1, wherein said sensor is a coil, said coil detecting changes in the magnetic field generated by said motor.

10. The miniature transducer of claim 1, wherein said motor includes a magnet circuit defining an air gap and a coil disposed at least partially in said air gap, said coil being secured to said diaphragm, said electrical input signal driving said coil.

11. The miniature transducer of claim 1, wherein said motor includes a movable armature coupled to said diaphragm by a drive pin, a coil defining a coil tunnel, and a pair of stationary magnets defining a gap therebetween, said armature extending through said coil tunnel and said gap, said electrical input signal causing a magnetic field within said coil tunnel that moves said armature.

12. The miniature transducer of claim 1, wherein said motor includes a piezo member, said piezo member causing said diaphragm to move.

13. The miniature transducer of claim 1, wherein said electronic circuit comprises an analog-to-digital converter for converting said feedback signal to a digital signal representative of said feedback signal.

14. The miniature transducer of claim 1, wherein said acoustical energy is audible sound.

15. The miniature transducer of claim 1, wherein said acoustical energy is ultrasound.

16. The miniature transducer of claim 1, wherein said electronic circuit reduces distortion by adjusting said output signal in response to said feedback signal.

17. The miniature transducer of claim 1, wherein said electronic circuit includes a Class A amplifier for forming said output signal from said electrical input signal and said feedback signal.

18. The miniature transducer of claim 1, wherein said electronic circuit includes a Class B amplifier for forming said output signal from said electrical input signal and said feedback signal.

19. The miniature transducer of claim 1, wherein said electronic circuit includes a Class D amplifier for forming said output signal from said electrical input signal and said feedback signal.

20. The miniature transducer of claim 1, wherein said electronic circuit includes a PWM circuit for forming said output signal from said electrical input signal and said feedback signal.

21. The miniature transducer of claim 1, wherein said electronic circuit includes a PDM circuit for forming said output signal from said electrical input signal and said feedback signal.

22. The miniature transducer of claim 1, wherein said electronic circuit includes a digital signal processor for forming said output signal from said electrical input signal and said feedback signal.

23. The miniature transducer of claim 1, wherein said electronic circuit is an integrated circuit.

24. The miniature transducer of claim 1, wherein said electronic circuit is a monolithic integrated circuit wire-bonded to a substrate.

25. The miniature transducer of claim 1, wherein said electronic circuit is a flip-chip integrated circuit mounted on a substrate.

26. The miniature transducer of claim 1, wherein said electronic circuit is a flip-chip integrated circuit mounted on said diaphragm.

27. The miniature transducer of claim 1, wherein said sensor is made of a piezo-resistive material.

28. The miniature transducer of claim 1, wherein said electrical input signal is an analog audio signal.

29. The miniature transducer of claim 1, wherein said electrical input signal is a digital audio signal.

30. The miniature transducer of claim 29, wherein said electrical input signal is a formatted digital audio signal.

31. The miniature transducer of claim 1, wherein said output signal is adjusted to reduce at least one acoustical anomaly of the miniature transducer.

32. The miniature transducer of claim 31, wherein said at least one acoustical anomaly includes resonance.

33. The miniature transducer of claim 31, wherein said at least one acoustical anomaly includes distortion.

34. The miniature transducer of claim 1, wherein said output signal is adjusted to reduce mechanical stress on said diaphragm.

35. A miniature transducer for converting a digital audio signal into acoustical energy, said miniature transducer comprising:
a motor coupled to a diaphragm, said motor causing movement in said diaphragm in response to said digital audio signal,
a sensor for detecting the movement of said diaphragm, said sensor providing an analog feedback signal representative of the movement of said diaphragm, and
an electronic circuit coupled to said motor and mounted to said diaphragm, said electronic circuit comprising:
an analog-to-digital converter coupled to said sensor, said analog-to digital converter converting said analog feedback signal to a digital feedback signal, and
a digital signal processor (DSP) coupled to said motor, said DSP providing an analog output signal for driving said motor, said analog output signal being a function of said digital audio signal and said digital feedback signal.

36. The miniature transducer of claim 35, wherein said analog-to-digital converter is a multi-bit converter.

37. The miniature transducer of claim 35, wherein said analog-to-digital converter is a sigma delta modulator.

38. The miniature transducer of claim 35, wherein said digital audio signal is formatted according to a digital audio format.

39. The miniature transducer of claim 38, wherein said digital audio format is S/PDIF.

40. The miniature transducer of claim 38, wherein said digital audio format is given by AES/EBU.

41. The miniature transducer of claim 38, wherein said digital audio format is I2S.

42. The miniature transducer of claim 38, wherein said digital audio format is PCM.

43. The miniature transducer of claim 38, wherein said DSP includes a decoder for decoding said digital audio format.

44. The miniature transducer of claim 38, further comprising a decoder coupled to said DSP, said decoder decoding said digital audio format.

45. The miniature transducer of claim 35, wherein said DSP is a pure digital DSP.

46. A miniature speaker for converting an audio signal into acoustical energy, said miniature speaker comprising:
a housing defining an opening,
a magnetic circuit disposed within said opening of said housing,
a coil coupled to a diaphragm, said coil and said diaphragm being disposed in said opening of said housing, said magnetic circuit and said coil generating a magnetic field in response to said audio signal, said coil causing said diaphragm to move in response to changes in said magnetic field,
a sensor disposed within said housing, said sensor detecting the movement of said diaphragm and providing a feedback signal representative of said changes in said magnetic field, and
an electronic circuit electrically coupled to said coil, said electronic circuit providing an output signal for driving said coil, said electronic circuit having a first input and a second input, said first input being said audio signal and said second signal being said feedback signal.

47. A miniature speaker for converting an electrical signal into acoustical energy, said miniature speaker comprising:
a coil receiving said electrical signal,
a diaphragm coupled to said coil, said coil causing movement in said diaphragm in response to said electrical signal, and
a sensor positioned to detect the movement of said diaphragm, said sensor providing a feedback signal representative of the movement of said diaphragm to an electronic circuit, said electronic circuit providing an output signal for driving said coil, said output signal being formed by said electrical signal and said feedback signal.

48. A method of transducing an electrical input signal into sound energy in a miniature speaker, the method comprising the steps of:
receiving an electrical input signal in said miniature speaker,
inducing a magnetic field by passing said electrical input signal through a coil secured to a diaphragm,
generating a feedback signal representative of a characteristic representing transduction of said electrical input signal into said sound energy, and
combining, in an electronic circuit mounted on said diaphragm, said feedback signal with said electrical input signal to cause movement in said diaphragm.

49. The method of claim 48, wherein said characteristic is a change in said magnetic field.

50. The method of claim 48, wherein said characteristic is a movement of said diaphragm.

51. A method of transducing a digital audio signal into acoustical energy, the method comprising the steps of:
receiving a digital audio signal in a miniature speaker,
generating, in said miniature speaker, an analog audio driver signal from at least said digital audio signal,
generating, in said miniature speaker, a magnetic field by passing said analog audio driver signal through a coil secured to a diaphragm,
causing said diaphragm to move by changing said magnetic field,
generating, in said miniature speaker, an analog feedback signal representing movements of said diaphragm,
converting said analog feedback signal into a digital feedback signal,
outputting from a digital signal processor said analog driver signal formed by at least said digital feedback signal and said digital audio signal, and
driving said coil by said analog driver signal.

52. A method of transducing an electrical signal into acoustical energy in a miniature transducer, the method comprising the steps of:
receiving said electrical signal in said miniature transducer,
forming an analog driver signal from at least said electrical signal,
generating a magnetic field by passing said analog driver signal through a coil,
providing a feedback signal representative of changes in said magnetic field, and
adjusting said analog driver signal by combining said electrical signal with said analog driver signal.

53. A method of assembling a miniature speaker, the method comprising the steps of:
providing a housing having a volume of less than about 6000 mm³, said housing having an opening,
disposing a motor in said housing, said motor including a magnet circuit and a coil,
securing a diaphragm to said coil, said diaphragm having a conductive layer; coupling an electronic circuit to said motor,
mounting said electronic circuit to said diaphragm, and
forming a plate capacitor sensor having a first plate and a second plate, said first plate being said conductive layer of said diaphragm, said second plate being a conductive layer of a front plate disposed over the opening of said housing.

54. A method of assembling a miniature speaker, the method comprising the steps of:
providing a housing,
disposing a motor in said housing, said motor including a magnet circuit and a coil, said motor providing an analog driver signal for driving said coil,
securing a diaphragm having an area of less than about 650 mm² to said coil, said diaphragm undergoing movement in response to said analog driver signal; coupling an electronic circuit to said motor,
forming a sensor coupled to said electronic circuit, said sensor providing a feedback signal representative of movements in said diaphragm, and
adjusting said analog driver signal based on at least said feedback signal, wherein said adjusting reduces at least one unwanted acoustical anomaly of said miniature speaker.

55. The method of claim 54, wherein said acoustical anomaly is resonance.

56. The method of claim 54, wherein said acoustical anomaly is distortion.

57. A method of assembling a generally rectangular miniature speaker, the method comprising the steps of:
providing a generally rectangular housing, said housing having an opening,
disposing a motor in said housing, said motor including a generally rectangular magnet circuit and a coil,
mounting a generally rectangular diaphragm to said coil, said diaphragm having a conductive layer,
coupling an electronic circuit to said motor, and
mounting said electronic circuit on said diaphragm.

58. A miniature acoustic speaker for converting an electrical input signal into an acoustical output signal, comprising:
a motor for driving a diaphragm for emission of said acoustical output signal,
a sensor for detecting a characteristic representing transduction of said electrical input signal into said acoustical output signal, said sensor providing a feedback signal representative of the movement of said diaphragm, and
an electronic circuit electrically coupled to said motor, said electronic circuit providing an output signal to said motor for driving said diaphragm, said output signal being defined by said electrical input signal and said feedback signal, said electronic circuit being mounted on said diaphragm.

59. The miniature acoustic speaker of claim 58, wherein said characteristic is a movement of said diaphragm.

60. The miniature acoustic speaker of claim 58, wherein said sensor is an accelerometer located on the diaphragm, said accelerometer detecting movements of said diaphragm.

61. The miniature acoustic speaker of claim 58, wherein said characteristic is a change in a magnetic field.

62. The miniature acoustic speaker of claim 61, wherein said motor includes a coil, said coil detecting changes in said magnetic field.

63. A miniature acoustic transducer for converting an electrical input signal into an acoustical output signal, comprising:
a motor for driving a diaphragm for emission of said acoustical output signal, said diaphragm having an area of less than about 650 mm²;
a sensor for detecting a characteristic representing transduction of said electrical input signal into said acoustical output signal, said sensor providing a feedback signal representative of the movement of said diaphragm, and
an electronic circuit electrically coupled to said motor, said electronic circuit providing an output signal to said motor for driving said diaphragm, said output signal being defined by said electrical input signal and said feedback signal.

64. The miniature acoustic speaker of claim 63, wherein said characteristic is a movement of said diaphragm.

65. The miniature acoustic speaker of claim 64, wherein said motor includes a magnet circuit for generating a magnetic field and a coil for driving said diaphragm, said characteristic is a change in said magnetic field.

66. A miniature acoustic transducer for converting an electrical input signal into an acoustical output signal, comprising:
a motor for driving a diaphragm for emission of said acoustical output signal,
a sensor for detecting a characteristic representing transduction of said electrical input signal into said acoustical output signal, said sensor providing a feedback signal representative of the movement of said diaphragm,
an electronic circuit electrically coupled to said motor, said electronic circuit providing an output signal to said motor for driving said diaphragm, said output signal being defined by said electrical input signal and said feedback signal, and
a housing for enclosing said motor, said sensor, and said electronic circuit, said housing having a volume of less than about 6000 mm².

67. A miniature acoustic transducer for converting an electrical input signal into an acoustical output signal, comprising:
a motor for driving a diaphragm for emission of said acoustical output signal,
a sensor for detecting a characteristic representing transduction of said electrical input signal into said acoustical output signal, said sensor providing a feedback signal representative of the movement of said diaphragm,
an electronic circuit electrically coupled to said motor, said electronic circuit providing an output signal to said motor for driving said diaphragm, said output signal being defined by said electrical input signal and said feedback signal, and
a housing for enclosing said motor, said sensor, and said electronic circuit, said housing substantially shielding said electronic circuit and said sensor against the effects of EMI.

68. A miniature acoustic speaker for converting an electrical input signal into an acoustical output signal, comprising:
a housing having a generally rectangular cross-section,
a motor within said housing for driving a generally rectangular diaphragm for emission of said acoustical output signal, said motor including a coil coupled to said diaphragm and a magnetic circuit, said magnetic circuit defining at least one generally rectangular magnetic gap in which said coil resides,
a sensor within said housing for detecting a characteristic representing transduction of said electrical input signal into said acoustical output signal, said sensor providing a feedback signal representative of the movement of said diaphragm, and
an electronic circuit within said housing and electrically coupled to said motor, said electronic circuit providing an output signal to said motor for driving said diaphragm, said output signal being defined by said electrical input signal and said feedback signal.
